(19) United States
(12) Patent Application Publication
(10) Pub. No.: US 2014/0067558 A1
(43) Pub. Date: Mar. 6, 2014

(54) IMAGE DISPLAY APPARATUS, IMAGE DISPLAY METHOD, AND RECORDING MEDIUM

(71) Applicant: Panasonic Corporation, Osaka (JP)

(72) Inventors: Toshiyuki TANAKA, Osaka (JP); Tsuneki YASUHO, Osaka (JP); Daisuke KUSABA, Osaka (JP); Keisuke IWATA, Osaka (JP); Tomohiko NISHIMURA, Hyogo (JP)

(73) Assignee: Panasonic Corporation, Osaka (JP)

(21) Appl. No.: 13/961,235

(22) Filed: Aug. 7, 2013

(30) Foreign Application Priority Data
Aug. 29, 2012 (JP) 2012-188910

(51) Int. Cl. G06Q 30/02

(52) U.S. Cl. CPC G06Q 30/0277
USPC 705/14.73

(57) ABSTRACT

The image display apparatus includes: a switch unit which receives a user control input; an advertisement storage for storing a first advertisement which is to be displayed upon receiving the user control input, and previously storing a second advertisement which is to be displayed at a next power-up of the image display apparatus and a third advertisement which is to be displayed upon receiving the user control input after the next power-up; an advertisement player which causes the first advertisement to be displayed on a screen upon receiving the user control input and causes the second advertisement to be displayed on the screen upon powering up the image display apparatus; and an advertisement manager which updates the first advertisement with the third advertisement upon powering up the image display apparatus.

### CROSS REFERENCE TO RELATED APPLICATION

The present application is based on and claims priority of Japanese Patent Application No. 2012-188910 filed on Aug. 29, 2012. The entire disclosure of the above-identified application, including the specification, drawings and claims is incorporated herein by reference in its entirety.

### FIELD

One or more exemplary embodiments disclosed herein relate generally to an image display apparatus, an image display method, and a recording medium, and relate particularly to a technique for presenting an advertisement to a viewer.

### BACKGROUND

In conventional apparatuses, a broadcast receiving apparatus which provides a GUI (graphical user interface) for controlling the apparatus and a video signal for displaying an advertisement has been known.

For example, Patent literature (PTL) 1 discloses a broadcast receiving apparatus which obtains various menu data including advertisement data (for example, a GUI such as a volume menu) from a broadcasted signal, stores the menu data in a storage of the apparatus, and provides a video signal for displaying the menu including the advertisement data when a user operates the apparatus to invoke the menu (for example, volume control).

A version number is given to the menu data. Thus, when the obtained menu data indicate a new version number, the broadcast receiving apparatus replaces the advertisement data by updating the menu data stored in the storage.

With such a broadcast receiving apparatus, in addition to a commercial video which is broadcasted between programs, an advertisement can be displayed when a user operates the apparatus. Furthermore, the advertisement to be displayed can be replaced as needed. Accordingly, such an apparatus develops an opportunity for advertisement business.

### CITATION LIST

### Patent Literature

[PTL1] Japanese Unexamined Patent Application Publication No. 2002-101360

### SUMMARY

### Technical Problem

The foregoing advertisement displaying approach is expected to be widely used in various image display apparatuses, and thus a more effective technique for enhancing an effect of an advertisement, such as a technique for adaptively providing the advertisement to different image display apparatuses or a technique for presenting the advertisement in a diversified, amused and flexible manner, is required.

In terms of development of an opportunity for advertisement business, for example, it is effective to display the advertisement not only when a user operates the apparatus, i.e. upon receiving a user control input, but also when the apparatus is powered up. For example, the advertisement included in a splash screen is displayed upon powering up the apparatus.

Preferably, the advertisements that are related to each other (for example, advertisements for the same advertiser) are displayed in a session which is a period between power-up and power-off in the case where the respective advertisements are displayed upon both powering up the apparatus and receiving the user control input. With this, a consistent look and feel may be given to all advertisements in each session, which enhances an advertisement's appeal.

In view of this, one non-limiting and exemplary embodiment was conceived in order to solve such a problem, and provides an image display apparatus which can display the advertisements that are related to each other in each session, using as few storage resources as possible.

### Solution to Problem

In order to achieve one non-limiting and exemplary embodiment, an image display apparatus according to an aspect of the present disclosure includes: an input unit which receives a user control input; a storage unit for storing a first advertisement which is to be displayed upon receiving the user control input, and previously storing a second advertisement which is to be displayed at a next power-up of the image display apparatus and a third advertisement which is to be displayed upon receiving the user control input after the next power-up; a user-control advertisement reproduction unit which causes the first advertisement to be displayed on a screen upon receiving the user control input; a power-up advertisement reproduction unit which causes the second advertisement to be displayed on the screen upon powering up the image display apparatus; and an advertisement management unit which updates the first advertisement with the third advertisement upon powering up the image display apparatus.

### Advantageous Effects

An image display apparatus according to the present disclosure can update the first advertisement with the third advertisement upon powering up the image display apparatus, and subsequently display the updated first advertisement on the screen upon receiving the user control input. Accordingly, it is possible to display the previously-stored second and third advertisements in the next session without performing any process at the end of the current session. The second advertisement and the third advertisement are appropriately related to each other so as to be displayed in one session. They are prepared by a server or the like and then provided to the image display apparatus.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates a functional block diagram showing an exemplary configuration of an advertisement presenting system including an AV reproduction apparatus according to an embodiment.

FIG. 2 illustrates exemplary contents included in advertisement storage according to the embodiment.

FIG. 3A illustrates an exemplary power-up advertisement script according to the embodiment.

FIG. 3B illustrates an exemplary volume advertisement script according to the embodiment.

FIG. 4A illustrates a sequence diagram showing an exemplary operation according to the embodiment, which is carried out upon powering up the AV reproduction apparatus.

FIG. 4B illustrates a sequence diagram showing an exemplary operation according to the embodiment, which is carried out upon powering up the AV reproduction apparatus.

FIG. 4C illustrates a sequence diagram showing an exemplary operation according to the embodiment, which is carried out upon receiving a user control input.

FIG. 5 illustrates a flowchart showing a detailed exemplary advertisement displaying process according to the embodiment.

FIG. 6A illustrates an exemplary power-up advertisement according to the embodiment.

FIG. 6B illustrates an exemplary volume advertisement according to the embodiment.

FIG. 6C illustrates an exemplary power-up advertisement according to the embodiment.

FIG. 6D illustrates an exemplary volume advertisement according to the embodiment.

### DESCRIPTION OF EMBODIMENT

### (Circumstances Leading to the Present Disclosure)

As described in the section “Technical Problem”, in the case where the respective advertisements are displayed upon both powering up the apparatus and receiving the user control input, it is preferable that the advertisements that are related to each other (for example, advertisements for the same advertiser) be displayed in a session which is a period between power-up and power-off.

In view of this, the inventors conceived an image display apparatus which can display the advertisements that are related to each other in each session, using as few storage resources as possible. At this time, the inventors also focused on the configuration of the image display apparatus which uses three types of advertisement data to minimize the advertisement data and can display, for each session, the respective advertisements that are related to each other upon both powering up the apparatus and receiving the user control input.

These three types of advertisement data are: a first advertisement which is to be displayed upon receiving a user control input; a second advertisement which is to be displayed at a next power-up; and a third advertisement which is to be displayed upon receiving the user control input after the next power-up. The second advertisement and the third advertisement are related to each other.

The first advertisement is to be displayed in each session upon receiving the user control input, and thus needs to be stored during the session. The second advertisement and the third advertisement are related to each other and to be displayed in the next session. Thus, they needs to be obtained and stored in advance from a server during the current session in order to decrease the delay of displaying of the advertisements in the next session and allow the advertisement to be displayed before a connection to a communication network. It should be noted that the advertisement that has been displayed at the power-up for the current session need not be stored because the advertisement is no longer displayed.

When the advertisements are to be displayed in the next session using the three types of advertisement data, the second advertisement can be just displayed at the power-up. In contrast, if the first advertisement identical to that of the current session is just displayed upon receiving the user control input, the displayed advertisement may be not related to the second advertisement.

One possible solution to such a trouble is to update the first advertisement with the third advertisement at the end of the current session, for example. However, this solution has a disadvantage. This solution does not always work effectively when the current session is suddenly terminated by unplugging the image display apparatus or an unexpected power outage.

In view of this, the inventors considered carefully and achieved an image display apparatus and an image display method as disclosed below.

The image display apparatus according to an aspect of the present disclosure includes: an input unit which receives a user control input; a storage unit for storing a first advertisement which is to be displayed upon receiving the user control input, and previously storing a second advertisement which is to be displayed at a next power-up of the image display apparatus and a third advertisement which is to be displayed upon receiving the user control input after the next power-up; a user-control advertisement reproduction unit which causes the first advertisement to be displayed on a screen upon receiving the user control input; a power-up advertisement reproduction unit which causes the second advertisement to be displayed on the screen upon powering up the image display apparatus; and an advertisement management unit which updates the first advertisement with the third advertisement upon powering up the image display apparatus.

With this, the first advertisement can be updated with the third advertisement upon powering up the image display apparatus, and the updated first advertisement can be displayed on the screen upon receiving the user control input. As a result, it is possible to display the previously-stored second and third advertisements in the next session without performing any process at the end of the current session. The second advertisement and the third advertisement are appropriately related to each other so as to be displayed in one session. They are prepared by a server or the like and then provided to the image display apparatus.

In addition, the advertisement management unit may update the first advertisement with the third advertisement by: deleting the first advertisement from the storage unit after the image display apparatus is powered up and before the input unit receives the user control input; and subsequently storing the third advertisement in the storage unit as a new first advertisement, and the user-control advertisement reproduction unit may cause the new first advertisement to be displayed on the screen upon receiving the user control input only when the new first advertisement exists in the storage unit.

It is ensured that this prevents the first advertisement that has been displayed in the last session from being displayed in a new session because the first advertisement is deleted before the user control input is received.

In addition, a period when the first advertisement does not exist in the storage unit can be purposefully used to control the displaying of the first advertisement. For example, in a manner that delays the timing for storing the third advertisement in the storage unit as a new first advertisement, even when the user control input is received, it is possible not to display the first advertisement until the impression of the second advertisement displayed at the power-up fades. Such a control is useful to keep the better impression of the advertisement and enhance the effect of the advertisement.

In addition, the advertisement management unit may: receive, from a server, a fourth advertisement which is to be displayed at a next power-up of the image display apparatus and a fifth advertisement which is to be displayed upon receiving the user control input after the next power-up; store the fourth advertisement in the storage unit as a new second advertisement after the second advertisement is displayed on the screen; and store the fifth advertisement in the storage unit as a new third advertisement after the first advertisement is updated with the third advertisement.

With this, the server handles, among many advertisements, the advertisements that are related to each other, and the image display apparatus can obtain, from the server, the fourth and the fifth advertisements as the advertisements that are appropriately related to each other so as to be displayed in the next session. As a result, the image display apparatus can store and display, using few storage resources, the advertisements that are related to each other in each session because the image display apparatus need not store many advertisements to handle the advertisement that are related to each other.

In addition, the advertisement management unit may: delete the first advertisement from the storage unit and temporarily save the third advertisement after the image display apparatus is powered up and before the input unit receives the user control input; receive, from a server, a fourth advertisement which is to be displayed at a next power-up of the image display apparatus and a fifth advertisement which is to be displayed upon receiving the user control input after the next power-up; store the fourth advertisement in the storage unit as a new second advertisement after the second advertisement is displayed on the screen; store the fifth advertisement in the storage unit as a new third advertisement after the third advertisement is temporarily saved; and store the temporarily-saved third advertisement in the storage unit as a new first advertisement, and the user-control advertisement reproduction unit causes the new first advertisement to be displayed on the screen upon receiving the user control input only when the new first advertisement exists in the storage unit.

With this, a process of temporarily saving the first advertisement and updating the first advertisement with the third advertisement and a process of updating the third advertisement with the fifth advertisement received from the server can be performed in parallel. Accordingly, in addition to the foregoing advantage, this is useful to improve a processing efficiency.

In addition, the advertisement management unit may: receive, from a server, a fourth advertisement which is to be displayed at a next power-up of the image display apparatus and a fifth advertisement which is to be displayed upon receiving the user control input after the next power-up; determine whether or not the received fifth advertisement can be reproduced by the user-control advertisement reproduction unit; and stores the received fifth advertisement in the storage unit as a new third advertisement only when it is determined that the received fifth advertisement can be reproduced.

This prevents the image display apparatus from storing the unavailable fifth advertisement as a third advertisement for the next session.

In addition, the advertisement management unit may send an advertisement-reproduction report to a server when the user-control advertisement reproduction unit has reproduced the first advertisement.

With this, the image display apparatus can be appropriately used for an advertisement presenting system which requires the advertisement-reproduction report when the advertisement is displayed.

In addition, the user-control advertisement reproduction unit may cause the first advertisement to be displayed on the screen upon receiving the user control input only after the image display apparatus is connected to a communication network.

This prevents the first advertisement from being displayed while the image display apparatus fails to send the advertisement-reproduction report, when the image display apparatus is used for the advertisement presenting system which requires the advertisement-reproduction report when the advertisement is displayed.

In addition, the first advertisement includes frequency-of-displaying information indicating a specified frequency of displaying the first advertisement, and the user-control advertisement reproduction unit may cause the first advertisement to be displayed on the screen only when a frequency of displaying the first advertisement does not exceed the specified frequency of displaying the first advertisement.

With this, the frequency of displaying the advertisement can be controlled. Accordingly, a user's feeling of irritation caused by the displaying of the advertisement is reduced, and the possibility that a user may get tired of looking at the advertisement is also reduced. As a result, it is expected to appropriately maintain the effect of the advertisement.

It should be noted that these general or specific aspects may be implemented by a system, a method, an integrated circuit, a computer program, a recording medium such as a computer-readable CD-ROM, or any combination of them.

### Embodiment

Hereinafter, an image display apparatus according to an aspect of the present disclosure is described with reference to the accompanying drawings.

It should be noted that an embodiment described below is a specific example of the present disclosure. The numerical values, shapes, constituent elements, steps, the processing order of the steps etc. shown in the following embodiment are mere examples, and thus do not limit the present disclosure. Thus, among the constituent elements in the following embodiment, constituent elements not recited in any of the independent claims indicating the most generic concept of the present disclosure are described as preferable constituent elements.

### (Advertisement Presenting System)

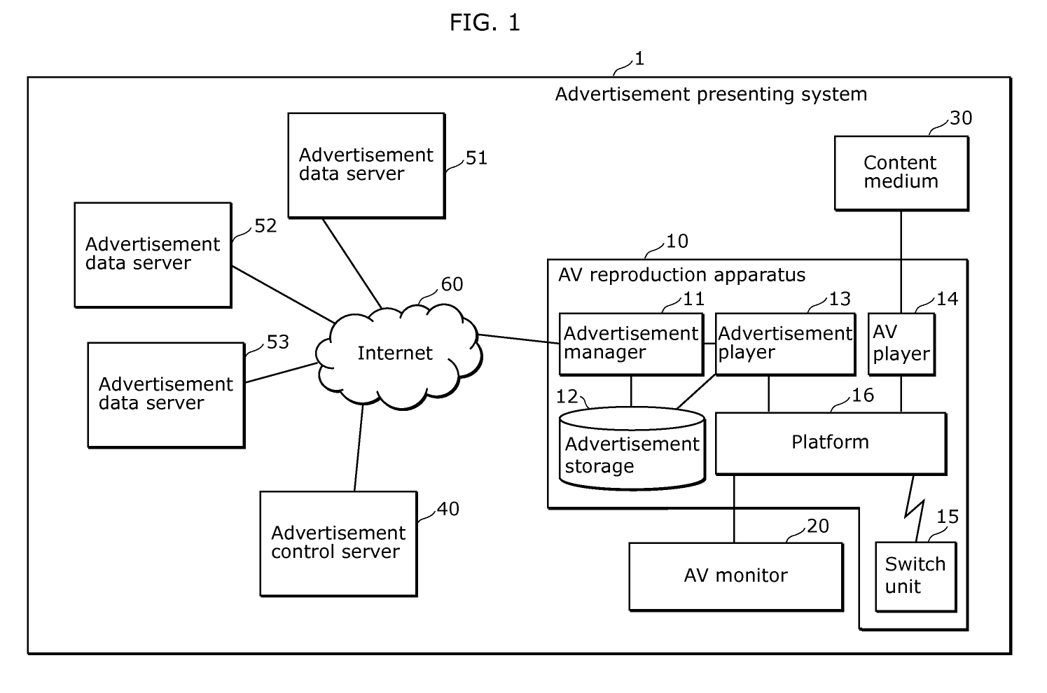

FIG. 1 illustrates a functional block diagram showing an exemplary configuration of an advertisement presenting system according to an embodiment.

The advertisement presenting system 1 is a system for presenting respective advertisements upon both powering up an audio and visual (AV) reproduction apparatus 10 and receiving a user control input for the AV reproduction apparatus 10, which includes the AV reproduction device 10, an AV monitor 20, a content medium 30, an advertisement control server 40, advertisement data servers 51 to 53, and Internet 60.

The AV reproduction apparatus 10 is an exemplary image display apparatus, the AV monitor 20 is an exemplary screen, the advertisement control server 40 and the advertisement data servers 50 to 53 are exemplary servers, and Internet 60 is an exemplary communication network.

The AV reproduction apparatus 10 is an apparatus for reproducing an AV content received from the content medium 30, and outputting audio and displaying images on the AV monitor 20, which displays respective advertisements on the AV monitor 20 upon both powering up the AV reproduction apparatus 10 and receiving the user control input for the AV reproduction apparatus 10.

The AV monitor 20 is a device for outputting audio and displaying images, which includes a liquid crystal display device, a plasma display device, an organic light emitting (EL) display device, or a video projector, and a loudspeaker, for example. The AV monitor 20 may be integrated with the AV reproduction apparatus 10, or may be provided separately. The AV monitor 20 may be a display device capable of displaying three-dimensional images using disparity.

The content medium 30 is a medium which can hold the AV content that is not limited to a specific type of content. The content medium 30 includes any types of media which can hold the AC contents, such as a broadcasting channel, a communication line, a hard disk, an optical disk, and a semiconductor memory. Accordingly, the AV reproduction apparatus 10 includes any consumer electronic appliances (CE) for receiving the AV content from the content medium 30 and reproducing the received AV content, such as a terrestrial television receiver, a satellite television receiver, a cable television receiver, an Internet television receiver, a hard-disk type video recorder and player, a Digital Versatile. Disk (DVD) player, a Blu-Ray disk (BD) player, and a digital media frame.

The Internet 60 is an exemplary communication network where the AV reproduction apparatus 10 is interactively connected to the advertisement control server 40 and the advertisement data servers 51 to 53.

The advertisement control server 40 is provided as needed. The advertisement control server 40 is a server connected to the Internet 60, which designates one or more servers to be used by the AV reproduction apparatus 10 from among the advertisement data servers 51 to 53.

The advertisement data servers 51 to 53 are servers connected to the Internet 60, each of which stores advertisement descriptive data (hereinafter, referred to as an advertisement script) and advertisement data. The advertisement data servers 51 to 53 may be managed by different advertising companies.

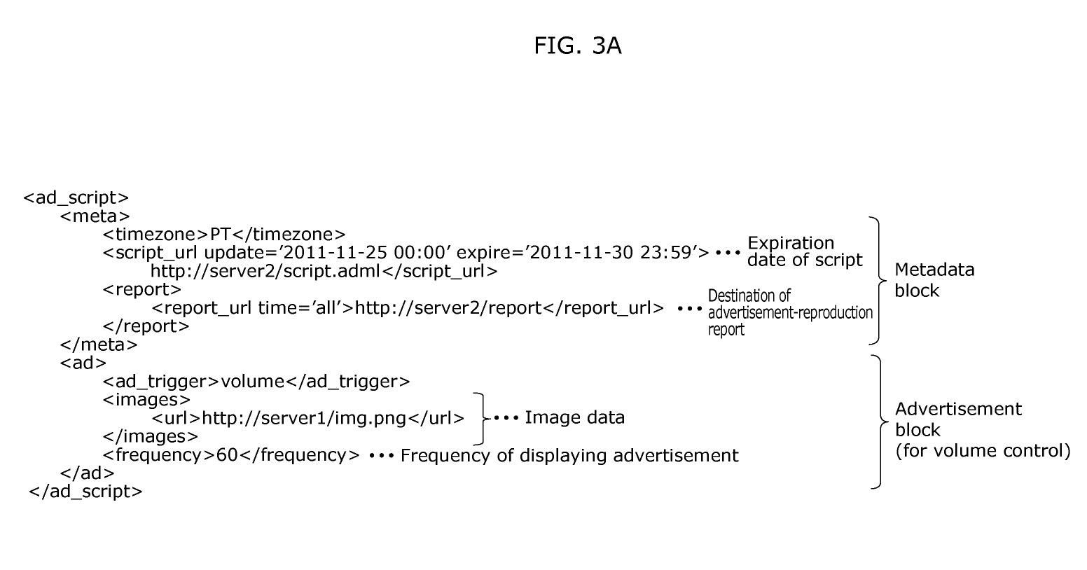

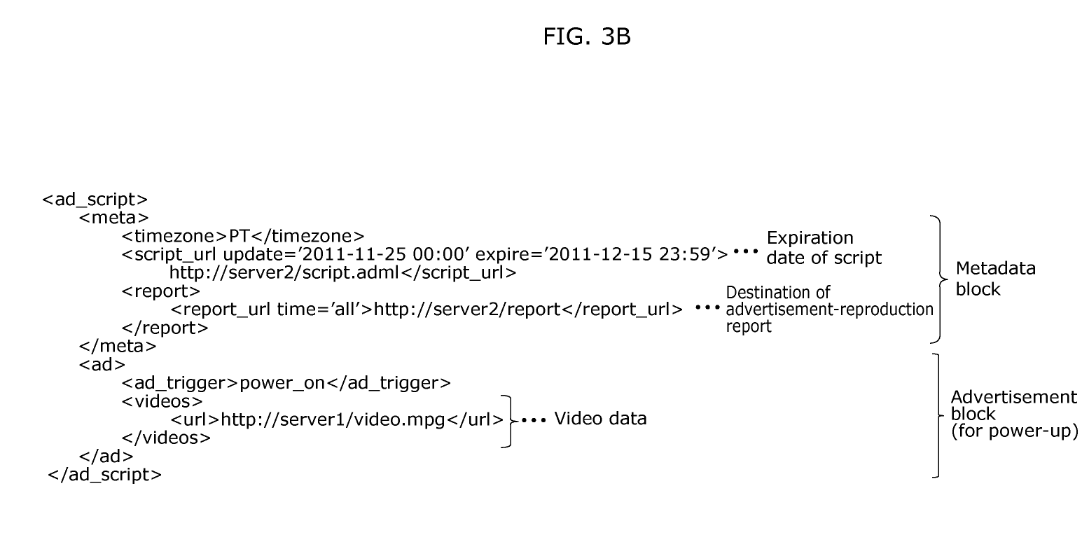

The advertisement script is data describing a Uniform Resource Locator (URL) of the advertisement data, a reproduction rule of the advertisement, and the like. The advertisement data is a main body of the advertisement, such as image data, animation data, or video data. One advertisement is displayed using one advertisement script and one or more types of advertisement data referenced by the one advertisement script. The advertisement script is described below in detail with reference to FIG. 3A and FIG. 3B.

The AV reproduction apparatus 10 obtains, via the Internet 60, the advertisement scripts and the advertisement data stored in the advertisement data servers 51 to 53. The AV reproduction apparatus 10 may be informed by the advertisement control server 40 of addresses of the advertisement data servers 51 to 53 to obtain the advertisement scripts and the advertisement data.

The AV reproduction apparatus 10 also may send, to the predetermined server via the Internet 50, an advertisement-reproduction report indicating that the advertisement has been displayed, when displaying the advertisement.

### (AV Reproduction Apparatus)

The AV reproduction apparatus 10 is described in detail.

As shown in FIG. 1, the AV reproduction apparatus 10 includes an advertisement manager 11, and advertisement storage 12, an advertisement player 13, an AV player 14, a switch unit 15, and a platform 16.

The advertisement manager 11 is a manager of the advertisement script and the advertisement data. The advertisement manager 11 obtains the advertisement script and the advertisement data from the advertisement data servers 51 to 53 via the Internet 60, and stores and maintains the received advertisement script and advertisement data in the advertisement storage 12. The advertisement manager 11 may have a network adapter to be used to access the Internet 60. The advertisement manager 11 is an exemplary advertisement management unit.

The advertisement storage 12 is a storage device for storing the obtained advertisement script and advertisement data. The advertisement storage 12 may includes a hard disk drive, a semiconductor memory drive, or the like.

The advertisement player 13 is a renderer for interpreting and executing the advertisement script to reproduce the advertisement. The advertisement player 13, which is activated by the platform 16, decodes and reproduces the advertisement data such as an image, an animation, or a video according to the description of the advertisement script. The advertisement player 13 may decode and reproduce the advertisement data using an image codec, an audio codec, a video codec, and an interpreter for animation included in the platform 16. The advertisement player 13 is an exemplary power-up advertisement reproduction unit and is also an exemplary user-control advertisement reproduction unit.

The AV player 14 is a decoder for AV content. The AV player 14 obtains the AV content from the content medium 30, and reproduces the obtained AV content. The AV player 14 may have a configuration appropriate to the content medium 30, for example, a television tuner, a network adapter, a hard disk drive, an optical disk drive, a disk adapter, or the like, to obtain the AV content. The AV player 14 may decode the AV content using an audio codec and a video codec included in the platform 16.

The switch unit 15 is an interface for receiving the user control input. The switch unit 15 may be an infrared remote control for example. The switch unit 15 receives, from a user, the user control input for the AV reproduction apparatus 10, for example, power-up/off control of the AV reproduction apparatus 10, volume control, or channel control, and informs the platform 16 of details about the received user control input. The switch unit 15 is an exemplary input unit.

The platform 16 is a generic term used to refer to a component for providing basic functions of the AV reproduction apparatus 10. The platform 16 includes hardware such as a central processing unit (CPU), a graphic processing unit (GPU), a random access memory (RAM), and a read only memory (ROM), and middleware such as a total controller of the AV reproduction apparatus 10, an image codec, an audio codec, a video codec, and an interpreter for animation.

The platform 16 totally controls the AV reproduction apparatus 10 based on the user control input informed by the switch unit 15.

Upon being informed by the switch unit 15 of the user control input, the platform 16 instructs the advertisement player 13 to reproduce the advertisement and generate a GUI corresponding to the user control (for example, a slide bar for volume control when the user control is volume control). Then, the advertisement reproduced by the advertisement player 13 and the generated GUI are synthesized. While the AV player 14 is reproducing the AV content, the GUI synthesized with the advertisement is superimposed on a reproduced image of the AV content. The GUI is an exemplary control menu.

The platform 16 generates an AV signal for the AV content synthesized with the advertisement and the GUI, and provides the generated AV signal to the AV monitor 20.

The middleware included in the foregoing advertisement manager 11, advertisement player 13, AV player 14, and platform 16 may be implemented by software which causes a CPU to execute a specific program recoded on a ROM, or hardware such as an integrated circuit. The middleware itself may be obtained from an outside server.

### (Advertisement Storage)

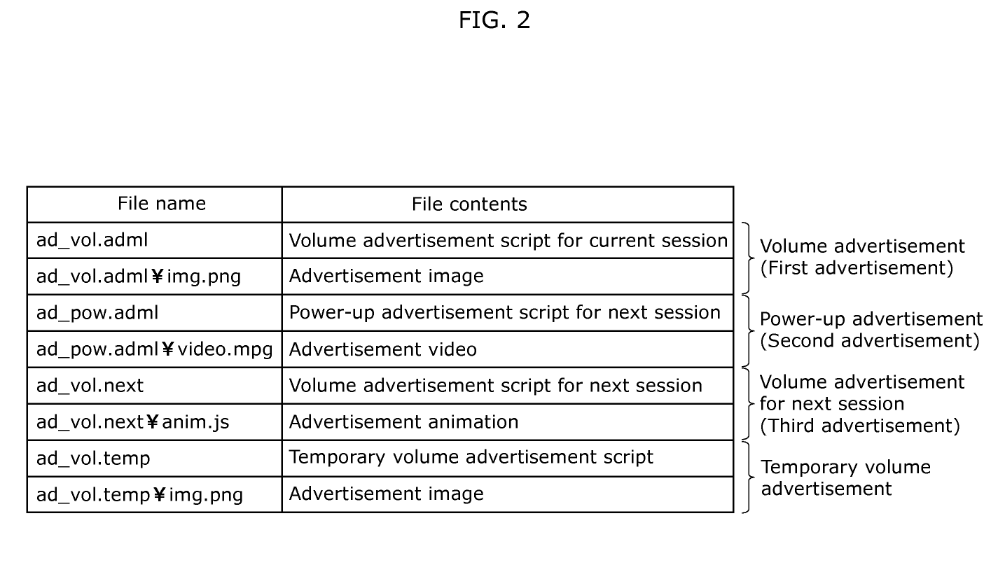

FIG. 2 illustrates an exemplary advertisement script and exemplary advertisement data stored in the advertisement storage 12. The advertisement storage 12 stores each of the advertisement scripts and the corresponding advertisement data obtained from the advertisement data servers 51 to 53 as a file with the predetermined file name.

As shown in FIG. 2, the advertisement storage 12 stores a power-up advertisement script for the next session, a volume advertisement script for the current session, and a volume advertisement script for the next session as “ad pow.adm1”, “ad_vol.adml”, and “ad_vol.next”, respectively. In addition, a temporary volume advertisement script is temporarily saved as “ad_vol.temp”. Furthermore, the advertisement data referenced by each advertisement script is stored as one or more files associated with the advertisement script (for example, one or more files that are saved in the folder identical to the folder where the advertisement script is saved).

A file operation such as move, delete, or rename for files containing one advertisement script and one or more types of advertisement data referenced by the one advertisement script (i.e. a data group representing one advertisement) is performed on the files at the same time based on the foregoing file association.

The volume advertisement script for the current session and the advertisement data referenced by the advertisement script are regarded as a data group representing an advertisement to be displayed upon receiving the volume control input in the current session, and hereinafter also just referred to as a “volume advertisement”. The volume advertisement is an exemplary first advertisement.

Similarly, the power-up advertisement script for the next session and the advertisement data referenced by the advertisement script are regarded as a data group representing an advertisement to be displayed at the next power-up, and hereinafter also just referred to as a “power-up advertisement”. The power-up advertisement is an exemplary second advertisement.

Furthermore, the volume advertisement script for the next session and the advertisement data referenced by the advertisement script are regarded as a data group representing an advertisement to be displayed upon receiving the volume control input in the next session, and hereinafter also just referred to as a “volume advertisement for the next session”. The volume advertisement for the next session is an exemplary third advertisement.

The advertisement script may be text data written in a mark-up language for example. In such an advertisement script, a URL of the advertisement data and advertisement metadata defining a reproduction rule of the advertisement are written by tagging them with respective predetermined tags.

The advertisement data may be image data in Portable Network Graphics (PNG) or Joint Photographic Experts Group (JPEG) format, animation data in JavaScript (JS) or Flash (SWF) format, or video data in Moving Picture Experts Group (MPEG) or QuickTime Movie (MOV) format, for example.

### (Advertisement Script)

FIG. 3A and FIG. 3B illustrate exemplary advertisement scripts. As shown in FIG. 3A and FIG. 3B, the advertisement script comprises a metadata block and an advertisement block. The metadata block describes an expiration date of the advertisement script and a destination of the advertisement-reproduction report. The advertisement block describes the URL of the advertisement data and a specified frequency of displaying the advertisement if necessary.

In the volume advertisement script as shown in FIG. 3A, the metadata block describes that the advertisement script expires at 23:59 on Nov. 30, 2011 and the advertisement-reproduction report is to be sent to http://server2/report. The advertisement block designates image data http://server1/img.png as the advertisement to be displayed when the volume control input is received, and describes a value 60 as the specified frequency of displaying the advertisement. This means that an upper limit on the frequency of displaying the volume advertisement is once per 60 minutes.

In the power-up advertisement script as shown in FIG. 3B, the expiration date, the destination of the advertisement-reproduction report, and the video data http://server1/video.mpg designated as the advertisement to be displayed at the power-up are written in the same syntax as the volume advertisement script as shown in FIG. 3A. The power-up advertisement script omits the specified frequency of displaying the advertisement.

### (Operation of AV Reproduction Apparatus)

The operation of the foregoing AV reproduction apparatus 10 is described next.

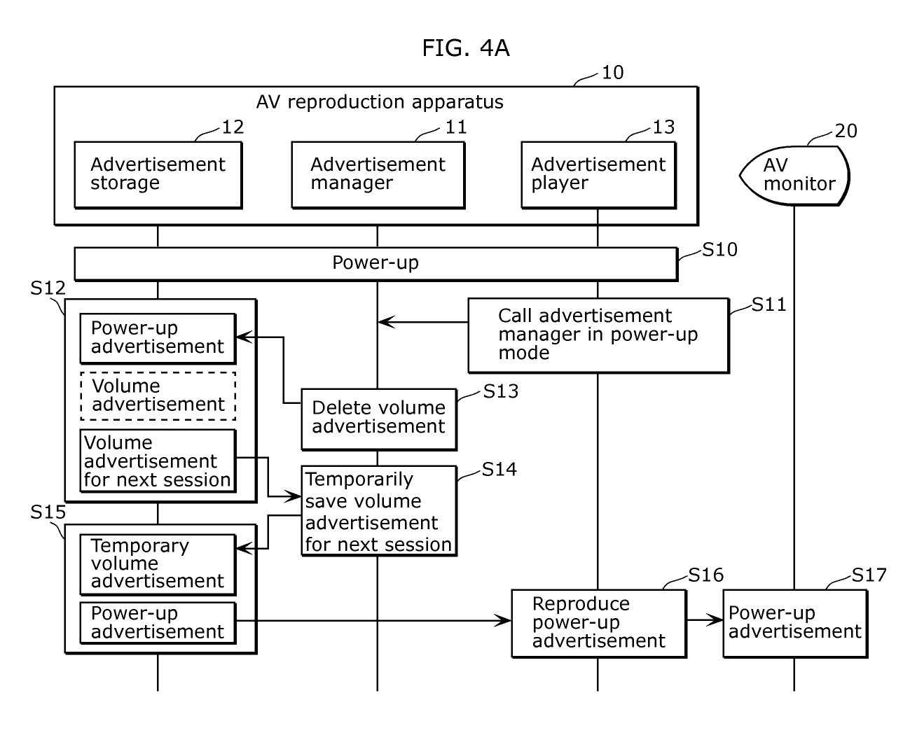

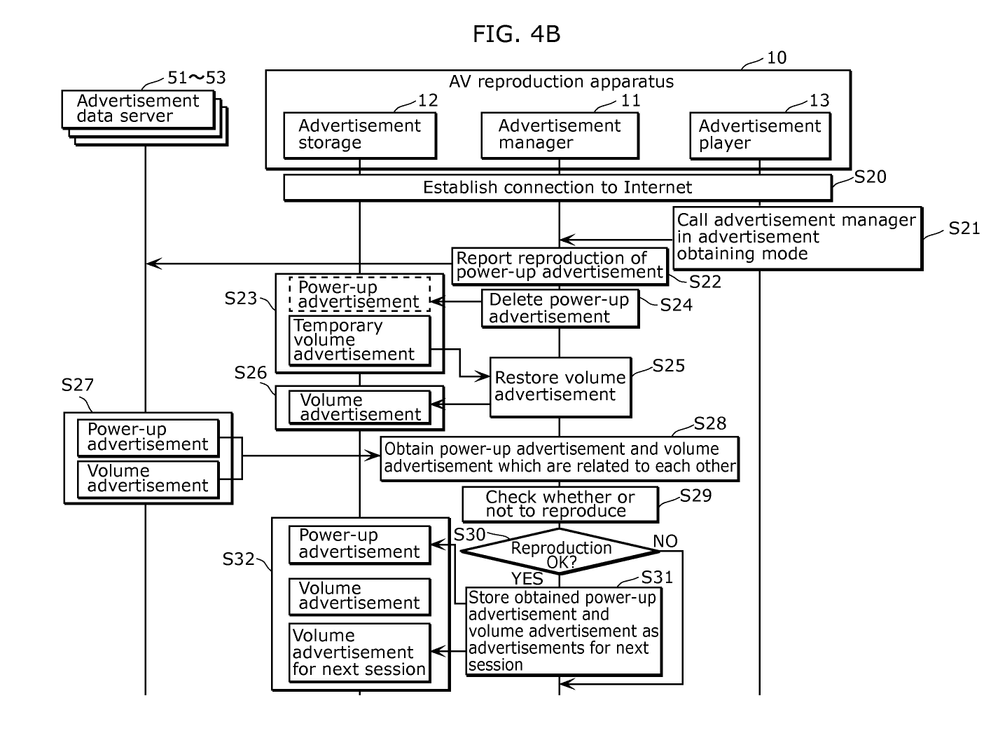

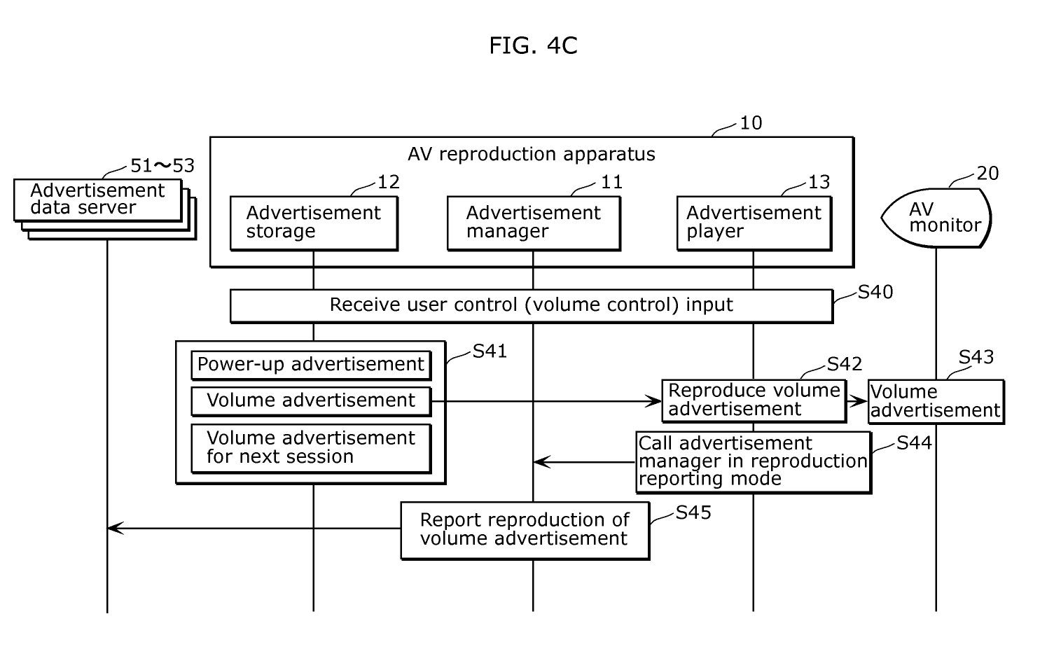

FIG. 4A illustrates an exemplary sequence diagram showing the first half of the operation to be performed upon powering up the AV reproduction apparatus 10 (i.e. triggered by the power-up of the AV reproduction apparatus 10). This sequence may be performed as a part of the initializing process for the entire AV reproduction apparatus 10.

When the AV reproduction apparatus 10 is powered up (S10), the advertisement player 13 calls the advertisement manager 11 in a power-up mode (S11). At this point, the advertisement storage 12 has stored, since the end of the last session, a power-up advertisement, a volume advertisement, and a volume advertisement for the next session (S12).

First, the advertisement manager 11 called in the power-up mode deletes the volume advertisement stored in the advertisement storage 12 (S13), and temporarily saves the volume advertisement for the next session (S14). As shown in FIG. 4A, the file name of the volume advertisement for the next session may be changed to a file name for a temporary volume advertisement so as to temporarily save the volume advertisement for the next session.

As a result of such an operation, the advertisement storage 12 stores the power-up advertisement and the temporary volume advertisement (S15). The volume advertisement has been deleted, so that the volume advertisement used in the last session can not be displayed anymore. In addition, the volume advertisement for the next session is temporarily saved, so that a new volume advertisement for the next session can be obtained from a server and stored anytime.

The advertisement player 13 reproduces the power-up advertisement stored in the advertisement storage 12 (S16), and causes the reproduced power-up advertisement to be displayed on the AV monitor 20 (S17).

The advertisement player 13 may reproduce the power-up advertisement only within the expiration date of the power-up advertisement script (not shown). For example, a clock showing the current day and time may be provided to the AV reproduction apparatus 10 to determine whether or not to be within the expiration date by comparing the expiration data of the power-up advertisement script stored in the advertisement storage 12 with the current day and time shown by the clock. The advertisement player 13 which causes the power-up advertisement to be displayed or not displayed selectively records reproduction result information indicating whether or not the power-up advertisement has been reproduced.

The displaying of an expired power-up advertisement, for example, when the AV reproduction apparatus 10 has not been powered up for a long time, can be prevented by determining whether or not the power-up advertisement script is valid.

FIG. 4B is an exemplary sequence diagram showing the latter half of the operation to be performed upon powering up the AV reproduction apparatus 10 (i.e. triggered by the power-up of the AV reproduction apparatus 10), and illustrates the operation following that in FIG. 4A, which is performed after a connection to the communication network of the AV reproduction apparatus 10 is established. This sequence may be performed as a part of the initializing process for a communication system of the AV reproduction apparatus 10.

When the connection to the Internet 60 is established (S20), the advertisement player 13 calls the advertisement manager 11 in an advertisement obtaining mode (S21). At this point, the advertisement player 13 informs the advertisement manager 11 of the reproduction result information if it is recorded.

The advertisement manager 11 called in the advertisement obtaining mode sends, via the Internet 60, the advertisement-reproduction report showing that the power-up advertisement has been reproduced to the destination of the advertisement-reproduction report which is indicated by the power-up advertisement script (S22). However, the advertisement manager 11 does not send the advertisement-reproduction report when the advertisement player 13 informs the reproduction result information indicating that the power-up advertisement failed to be reproduced.

As this point, the advertisement storage 12 stores the power-up advertisement and the temporary volume advertisement (S23). The advertisement manager 11 deletes the power-up advertisement (S24), and restores the volume advertisement (525). As shown in FIG. 4B, the advertisement manager 11 may change the file name of the temporary volume advertisement to the file name for the volume advertisement so as to restore the volume advertisement.

As a result of such an operation, the advertisement storage 12 stores the volume advertisement that has been updated with the volume advertisement for the next session, thereby allowing the updated volume advertisement to be displayed (S26). The volume advertisement for the next session is related to the power-up advertisement displayed at Step S16 in FIG. 4A.

It should be noted that a period when the volume advertisement does not exist on the advertisement storage 12 (from S13 to S25) can be purposefully used to control the displaying of the volume advertisement.

As shown in FIG. 4B, Step S25 is performed after the connection to the Internet 60 is established. This prevents the volume advertisement from being displayed while the AV reproduction apparatus 10 fails to send the advertisement-reproduction report, when the AV reproduction apparatus 10 is used for the advertisement presenting system 1 which requires the advertisement-reproduction report when the advertisement is reproduced.

In addition, in a manner that further delays the timing of Step S25, even when the volume control input is received, it is possible not to display the volume advertisement until the impression of the power-up advertisement displayed at the power-up fades. Such a control is useful to keep the better impression of the advertisement and enhance the effect of the advertisement.

The advertisement manager 11 obtains, from the advertisement data servers 51 to 53 via the Internet 60, the power-up advertisement and the volume advertisement which are related to each other so as to use them in the next session (S27 and S28).

The power-up advertisement to be obtained at Step S27 comprises the power-up advertisement script for the next session and the advertisement data referenced by it. This power-up advertisement is an exemplary fourth advertisement to be displayed at the next power-up.

The volume advertisement to be obtained at Step S27 comprises the volume advertisement script for the next session and the advertisement data referenced by it. This volume advertisement is an exemplary fifth advertisement to be displayed upon receiving the user control input after the next power-up.

The advertisement manager 11 determines whether or not the volume advertisement obtained at Step S27 can be reproduced by the advertisement player 13 (S29). This determining may be based on whether or not a codec required to reproduce the volume advertisement exists on the platform 16 of the AV reproduction apparatus 10. Only when it is determined that the volume advertisement can be reproduced by the advertisement player 13 (Yes at S30), the volume advertisement is stored in the advertisement storage 12 (S31 and S32).

The advertisement manager 11 also determines whether or not the power-up advertisement obtained at Step S27 can be reproduced by the advertisement player 13 in the same manner, and only when the power-up advertisement is determined to be reproduced, the power-up advertisement is stored in the advertisement storage 12 (S31 and S32).

This determining prevents the unavailable advertisement to be stored in the advertisement storage 12 as an advertisement for the next session.

It should be noted that FIG. 4A and FIG. 4B illustrate that the processes are performed sequentially, but include some parts of them that can be actually performed in parallel.

For example, in FIG. 4A, there is no data dependency between the first process of Steps S13 and S14 performed by the advertisement manager 11 and the second process of Step S16 performed by the advertisement player 13. Accordingly, these processes can be performed in parallel. Alternatively, the advertisement manager 11 may perform the process of Step S16, and the advertisement player 13 may perform the process of Steps S13 and S14.

Similarly, for example, in FIG. 4B, there is also no data dependency among the third process of Step S22, the fourth process of Steps S24 and S25, and the fifth process of Steps S28 to S31 performed by the advertisement manager 11. Accordingly, these processes can be performed in parallel.

On the other hand, when it is ensured that the fourth process and the fifth process are sequentially performed in this order, the volume advertisement (for the current session) is replaced with the volume advertisement for the next session before a new volume advertisement for the next session is obtained from a server. Accordingly, the temporary volume advertisement is not required. In this case, the volume advertisement can be directly updated with the volume advertisement for the next session without the temporary volume advertisement.

FIG. 4C illustrates an exemplary sequence diagram showing an operation to be performed upon receiving the user control input for the AV reproduction apparatus 10 (i.e. triggered by receiving the user control input). This sequence is performed when the switch unit 15 receives a control input for the AV reproduction apparatus 10 from a user. Hereinafter, the volume control is described as an exemplary user control.

When the switch unit 15 receives the volume control input (S40), the advertisement storage 12 stores the volume advertisement for the current session (S41). The advertisement player 13 reproduces the volume advertisement stored in the advertisement storage 12 (S42), and causes the reproduced volume advertisement to be displayed on the AV monitor 20 (S43).

The advertisement player 13 may reproduce the volume advertisement until the expiration date of the volume advertisement script in a similar manner to the power-up advertisement (not shown). Alternatively, the advertisement player 13 may reference the frequency-of-displaying information included in the volume advertisement script to reproduce the volume advertisement only when the frequency of displaying the volume advertisement does not exceed the specified frequency of displaying indicated by the frequency-of-displaying information. The control for selectively reproducing the advertisement based on various conditions is described below in detail.

The advertisement player 13 calls the advertisement manager in a reproduction reporting mode only when the volume advertisement has been reproduced (S44).

The advertisement manager 11 called in the reproduction reporting mode sends, via the Internet 60, the advertisement-reproduction report showing that the volume advertisement has been reproduced to the destination of the advertisement-reproduction report which is indicated by the volume advertisement script (S45).

Next, the reproduction processes of the power-up advertisement and the volume advertisement in the foregoing sequence are described in detail.

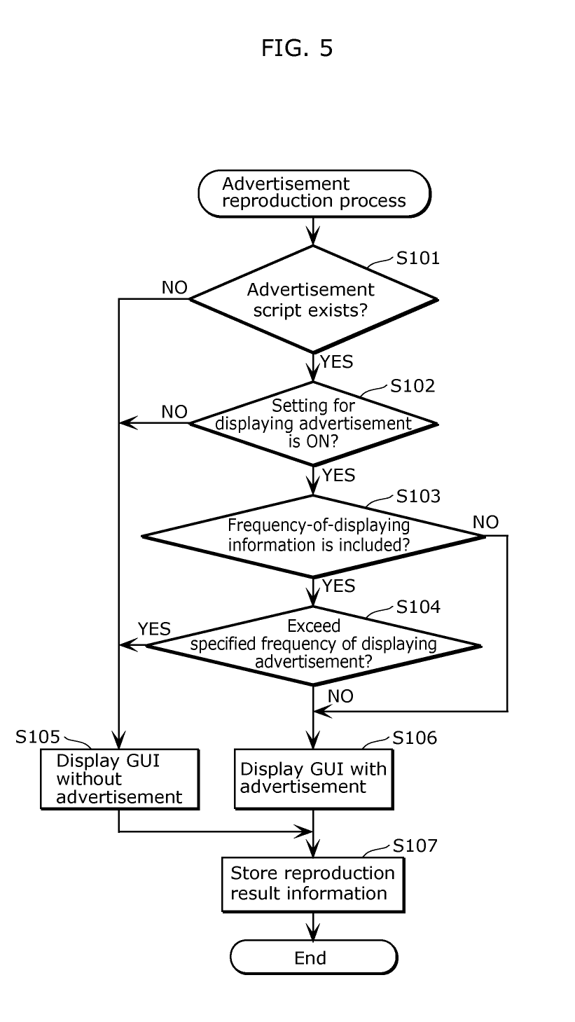

FIG. 5 illustrates a flowchart showing a detailed exemplary advertisement reproduction process performed by the advertisement player 13. The operation illustrated by this flowchart is applicable to both the reproduction of the power-up advertisement at Step S16 and the reproduction of the volume advertisement as Step S42. First, in order to reproduce the power-up advertisement or the volume advertisement, the advertisement player 13 checks that the advertisement script to be reproduced (the power-up advertisement script or the volume advertisement script) exists on the advertisement storage 12 (S101). When the power-up advertisement and the volume advertisement failed to be stored in the advertisement storage 12 in the last session (for example, when the network has failed to be connected correctly or the available advertisement could not be obtained), the power-up advertisement script or the volume advertisement script may not exist in the advertisement storage 12.

If the advertisement script to be reproduced does not exist (No at S101), the advertisement player 13 causes a GUI including no advertisement (such as a splash screen at the power-up or a slide bar for the volume control) to be displayed on the AV monitor 20 without reproducing the advertisement (S105).

If the advertisement script to be reproduced exists (YES at S101), a setting for displaying the advertisement of the AV reproduction apparatus 10 is checked (S102). This setting for displaying the advertisement is provided for a user to permit or prohibit the displaying of the advertisement by the AV reproduction apparatus 10, and can be set to ON or OFF by a user using a setting screen (not shown). The details of the setting are stored in the AV reproduction apparatus 10.

If the setting for displaying the advertisement of the AV reproduction apparatus 10 is OFF (NO at S102), the GUI including no advertisement is displayed (S105).

If the setting for displaying the advertisement of the AV reproduction apparatus 10 is ON (YES at S102), it is checked whether or not the frequency-of-displaying information is included in the advertisement script to be reproduced (S103). Assuming that the advertisement is displayed, if the frequency-of-displaying information is included (YES at S103), it is determined whether or not the frequency of displaying the advertisement exceeds the specified frequency of displaying the advertisement which is indicated by the frequency-of-displaying information (S104).

In the determining, as an example, when the frequency-of-displaying information indicates that an upper limit on the frequency of displaying the advertisement is once per 60 minutes, it is determined whether or not 60 minutes or more have passed since the last display. Assuming that the advertisement is displayed, if 60 minutes have not passed since the last display, it is determined that the frequency of displaying the advertisement exceeds the specified frequency of displaying the advertisement. The elapsed time since the last display may be obtained as a difference between the last displayed time and the current time, or may be obtained by measuring it with a timer.

If it is determined that the frequency of displaying the advertisement exceeds the specified frequency of displaying the advertisement (YES at S104), the GUI including no advertisement is displayed (S105).

Under the condition that (i) the advertisement script to be reproduced exists (YES at S101) and (ii) the setting for displaying the advertisement is ON (YES at S102), if (i) the frequency-of-displaying information is not included in the advertisement script (NO at S103) and (ii) the frequency-of-displaying information is included in the advertisement script and it is determined that the frequency of displaying the advertisement does not exceed the specified frequency of displaying the advertisement (NO at S104), the advertisement player 13 reproduces the advertisement. The reproduced advertisement is synthesized with the GUI by the platform 16, and the GUI including the advertisement (such as a splash screen with the advertisement at the power-up or a slide bar with the advertisement for the volume control) is displayed on the AV monitor 20 (S106).

It should be noted that the GUI need not be always displayed, for example, when the splash screen is not used or when the volume advertisement itself is designed to be a GUI which mimics the slide bar for the volume control. In this case, at Step S106, only the power-up advertisement or the volume advertisement is displayed on the AV monitor 20.

The advertisement player 13 records the reproduction result information indicating whether or not the advertisement has been reproduced (S107). As described above, the reproduction result information is used to control whether or not the advertisement-reproduction report is to be sent.

Thus, the AV reproduction apparatus 10: stores the volume advertisement which is to be displayed upon receiving the user control input; previously stores the power-up advertisement which is to be displayed at a next power-up of the AV reproduction apparatus and the volume advertisement for the next session which is to be displayed upon receiving the user control input after the next power-up; causes the previously-stored power-up advertisement to be displayed on the AV monitor 20 upon powering up the AV reproduction apparatus 10; updates the volume advertisement with the previously-stored volume advertisement for the next session upon powering up the AV reproduction apparatus 10; and causes the updated volume advertisement to be displayed on the AV monitor 20 upon receiving the user control input.

As a result, the AV reproduction apparatus 10 can display the power-up advertisement and volume advertisement which have been previously stored in the last session, in a new session without performing any process at the end of the current session.

In addition, the advertisement data servers 51 to 53 handle, among many advertisements, the advertisements that are related to each other. Accordingly, the AV reproduction apparatus 10 can obtain, from the advertisement data servers 51 to 53, only the advertisements that appropriately related to each other so as to be displayed in the next session, and can previously store them as the power-up advertisement and the volume advertisement for the next session. In other words, the AV reproduction apparatus 10 can store and display, using few storage resources, the advertisements that are related to each other in each session because the AV reproduction apparatus 10 need not store many advertisements to handle the advertisement that are related to each other.

(Specific Example of Displayed Advertisement)

Some specific examples of the advertisement displayed on the AV monitor 20 using the foregoing AV reproduction apparatus 10 are described. In the following description, an exemplary volume control which is performed by a user watching a weather report on TV is used as an example of the user control.

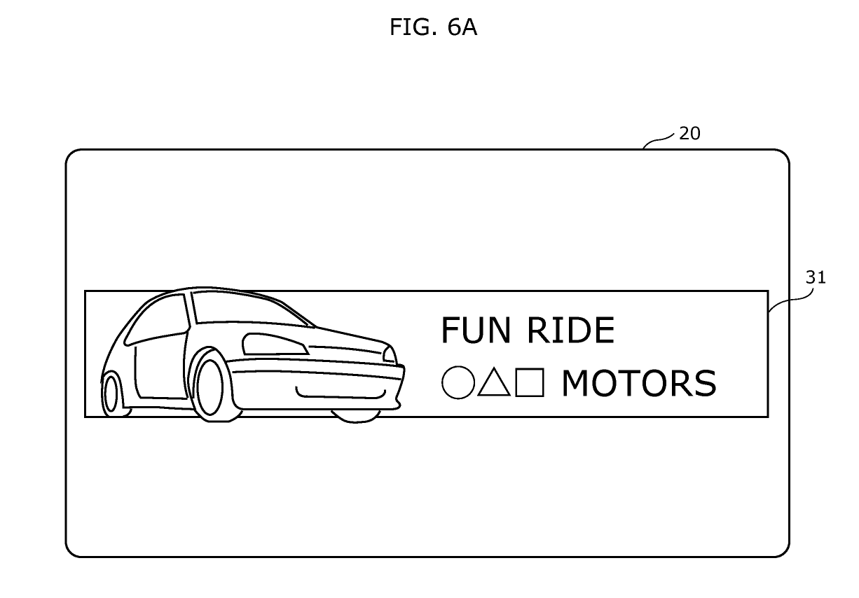

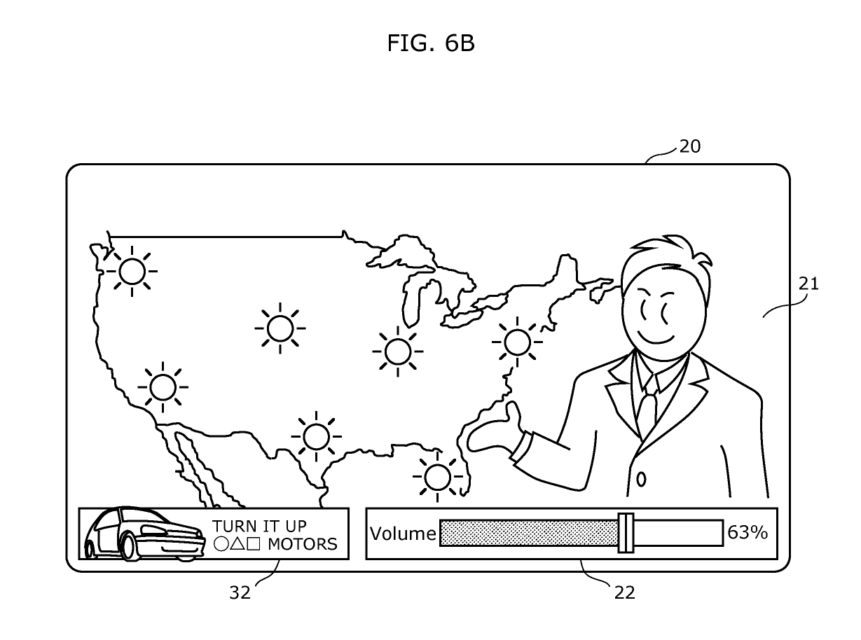

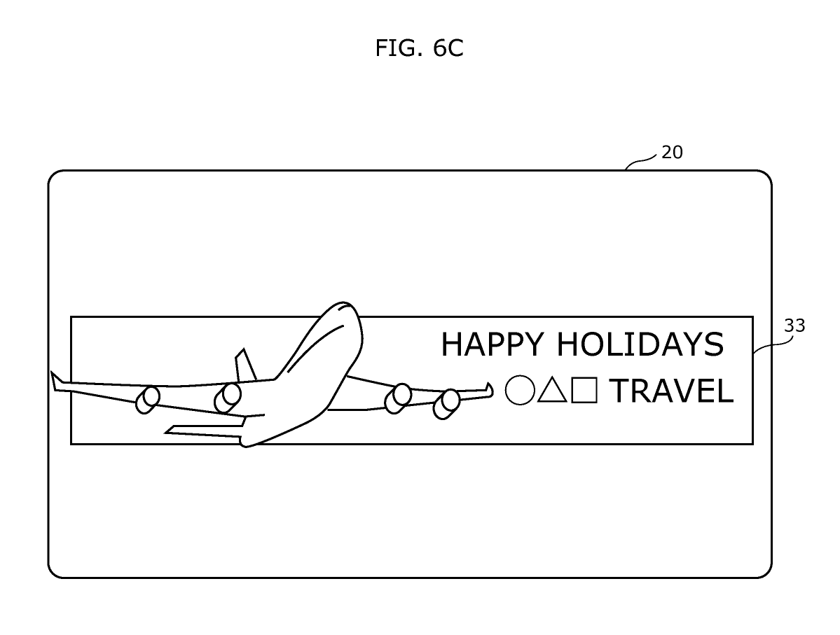

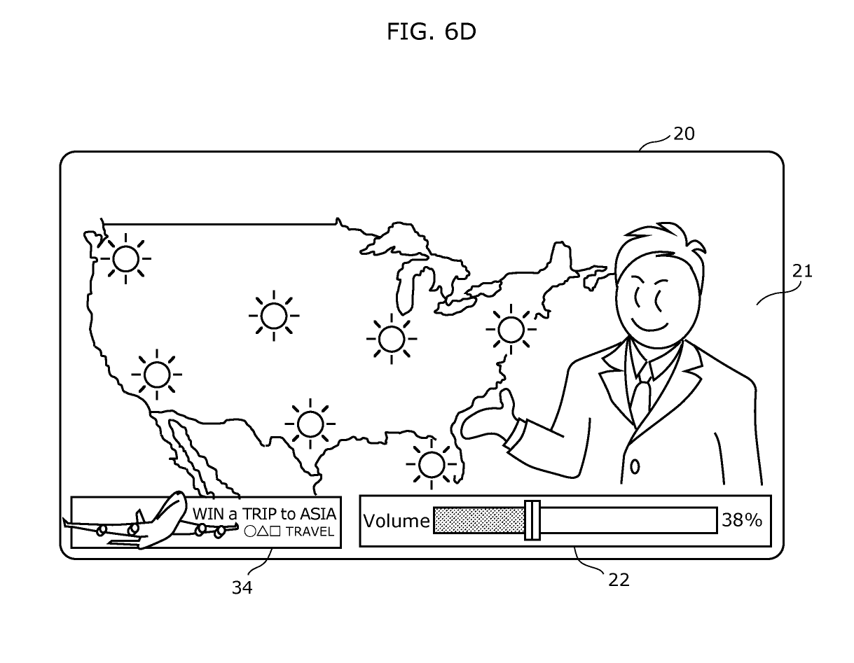

FIG. 6A and FIG. 6B illustrate an exemplary power-up advertisement and an exemplary volume advertisement which are displayed in the first session, respectively.

FIG. 6C and FIG. 6D illustrate an exemplary power-up advertisement and an exemplary volume advertisement which are displayed in the second session following to the first session, respectively.

In the first session, the AV reproduction apparatus 10 displays the power-up advertisement 31 of an automobile company (FIG. 6A), and also displays the volume advertisement 32 of the same automobile company while displaying the slide bar 22 for the volume control (FIG. 6B).

By the end of the first session, the AV reproduction apparatus 10 obtains, from the server, a new power-up advertisement and a new volume advertisement for the second session which are related to each other (for example, advertisements of the same travel company as shown in FIG. 6C and FIG. 6D), and previously stores them in the advertisement storage 12 as the power-up advertisement and the volume advertisement for the next session.

At the beginning of the second session, the advertisement storage 12 stores the volume advertisement of the automobile company, the power-up advertisement of the travel company, and the volume advertisement for the next session of the travel company.

In the second session, the AV reproduction apparatus 10 displays the power-up advertisement 33 of the travel company (FIG. 6C). After this, the volume advertisement of the automobile company is updated with the volume advertisement for the next session of the travel company. Consequently, as the volume advertisement in the second session, not the volume advertisement of the automobile company but the volume advertisement 34 of the travel company which is the same as that of the power-up advertisement 33 is displayed in addition to the slide bar 22 for the volume control (FIG. 6D).

Thus, the AV reproduction apparatus 10 can display the advertisements that are related to each other in each session, by storing and handling at least three types of advertisement data, i.e. the volume advertisement, the power-up advertisement, and the volume advertisement for the next session.

In addition, it is ensured that such an operation is performed even when the current session is suddenly terminated by unplugging the AV reproduction apparatus 10 or an unexpected power outage because the volume advertisement is updated with the volume advertisement for the next session at the power-up for the next session.

It should be noted that an animated advertisement may be used as the power-up advertisement or the volume advertisement. For example, the advertisement 31 or 32 may be a video or animation where a car is moving, and the advertisement 33 or 34 may be a video or animation where an airplane takes off and flies away into the sky. In particular, when the advertisement can be displayed at a relatively large size, for example, when the apparatus is powered up, the animated advertisement can impress a user more deeply.

In addition, instead of displaying the GUI, an area for displaying the advertisement may be moved on the screen to be more rightward as the volume increases and more leftward as decreases. In such a manner, the advertisement itself may be animated, or the animation may be created to cause the area for displaying the advertisement to move freely on the screen.

Although an image display apparatus according to one or more aspects of the present disclosure have been described in detail above, those skilled in the art will readily appreciate that various modifications may be made in these aspects without materially departing from the principles and spirit of the inventive concept, the scope of which is defined in the appended Claims and their equivalents.

For example, a user control input which is a trigger for displaying an advertisement is not limited to volume control. The user control includes one or more types of controls such as channel control besides the volume control, and the AV reproduction apparatus 10 may cause the advertisement corresponding to the received user control input to be displayed on the AV monitor 20.

In order to define advertisements corresponding to different types of user controls, for example, the advertisement script as shown in FIG. 3A may include the advertisement blocks each corresponding to a different type of user control, such as an advertisement block for the channel control (not shown) besides the advertisement block for the volume control. Each user control corresponding to a different advertisement block is tagged with a tag <ad_trigger>.

The AV reproduction apparatus 10 can display the advertisement according to the advertisement block corresponding to the received user control input, by reference to it.

In the embodiment, exemplary advertisements are described as images that are related to each other so as to be displayed in one session which is a period between power-up and power-off. However, the method of displaying the advertisements according to the present disclosure is applicable to not only the advertisements but also any images only when the images are related to each other.

### INDUSTRIAL APPLICABILITY

The present disclosure can be widely used for a system which reproduces an advertisement in a consumer electronic appliance.

1. An image display apparatus comprising:
an input unit configured to receive a user control input;
a storage unit for storing a first advertisement which is to be displayed upon receiving the user control input, and previously storing a second advertisement which is to be displayed at a next power-up of the image display apparatus and a third advertisement which is to be displayed upon receiving the user control input after the next power-up;
a user-control advertisement reproduction unit configured to cause the first advertisement to be displayed on a screen upon receiving the user control input;
a power-up advertisement reproduction unit configured to cause the second advertisement to be displayed on the screen upon powering up the image display apparatus; and
an advertisement management unit configured to update the first advertisement with the third advertisement upon powering up the image display apparatus.

2. The image display apparatus according to claim 1,
wherein the advertisement management unit is configured to update the first advertisement with the third advertisement by:
deleting the first advertisement from the storage unit after the image display apparatus is powered up and before the input unit receives the user control input; and
subsequently storing the third advertisement in the storage unit as a new first advertisement, and
the user-control advertisement reproduction unit is configured to cause the new first advertisement to be displayed on the screen upon receiving the user control input only when the new first advertisement exists in the storage unit.

3. The image display apparatus according to claim 1,
wherein the advertisement management unit is configured to:
receive, from a server, a fourth advertisement which is to be displayed at a next power-up of the image display apparatus and a fifth advertisement which is to be displayed upon receiving the user control input after the next power-up;
store the fourth advertisement in the storage unit as a new second advertisement after the second advertisement is displayed on the screen; and
store the fifth advertisement in the storage unit as a new third advertisement after the first advertisement is updated with the third advertisement.

4. The image display apparatus according to claim 1,
wherein the advertisement management unit is configured to:
delete the first advertisement from the storage unit and temporarily save the third advertisement after the image display apparatus is powered up and before the input unit receives the user control input;
receive, from a server, a fourth advertisement which is to be displayed at a next power-up of the image display apparatus and a fifth advertisement which is to be displayed upon receiving the user control input after the next power-up;
store the fourth advertisement in the storage unit as a new second advertisement after the second advertisement is displayed on the screen;
store the fifth advertisement in the storage unit as a new third advertisement after the third advertisement is temporarily saved; and
store the temporarily-saved third advertisement in the storage unit as a new first advertisement, and
the user-control advertisement reproduction unit is configured to cause the new first advertisement to be displayed on the screen upon receiving the user control input only when the new first advertisement exists in the storage unit.

5. The image display apparatus according to claim 1,
wherein the advertisement management unit is configured to:
receive, from a server, a fourth advertisement which is to be displayed at a next power-up of the image display apparatus and a fifth advertisement which is to be displayed upon receiving the user control input after the next power-up; and
determine whether or not the received fifth advertisement can be reproduced by the user-control advertisement reproduction unit, and store the received fifth advertisement in the storage unit as a new third advertisement only when it is determined that the received fifth advertisement can be reproduced.

6. The image display apparatus according to claim 1,
wherein the advertisement management unit is configured to send an advertisement-reproduction report to a server when the user-control advertisement reproduction unit has reproduced the first advertisement.

7. The image display apparatus according to claim 1,
wherein the user-control advertisement reproduction unit is configured to cause the first advertisement to be displayed on the screen upon receiving the user control input only after the image display apparatus is connected to a communication network.

8. The image display apparatus according to claim 1,
wherein the first advertisement includes frequency-of-displaying information indicating a specified frequency of displaying the first advertisement, and
the user-control advertisement reproduction unit is configured to cause the first advertisement to be displayed on the screen only when a frequency of displaying the first advertisement does not exceed the specified frequency of displaying the first advertisement.

9. An image display method comprising:
receiving a user control input;
storing a first advertisement which is to be displayed upon receiving the user control input, and previously storing a second advertisement which is to be displayed at a next power-up of the image display apparatus and a third advertisement which is to be displayed upon receiving the user control input after the next power-up;
causing the first advertisement to be displayed on a screen upon receiving the user control input;
causing the second advertisement to be displayed on the screen upon powering up the image display apparatus; and
updating the first advertisement with the third advertisement upon powering up the image display apparatus.

10. A non-transitory computer-readable recording medium having a program recorded thereon for causing a computer to execute the image display method according to claim 9.
